(19) United States
(12) Patent Application Publication
(10) Pub. No.: US 2010/0277676 A1
(43) Pub. Date: Nov. 4, 2010

(54) OPTICAL FILM AND LIQUID CRYSTAL PANEL AND LIQUID CRYSTAL DISPLAY USING THE SAME

(75) Inventors: Kazuki Uwada, Osaka (JP); Hiroyuki Yoshimi, Osaka (JP); Kentaro Takeda, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/747,046

(22) PCT Filed: Dec. 2, 2008
(86) PCT No.: PCT/JP2008/071868

§ 371 Date: Jul. 15, 2010

(30) Foreign Application Priority Data
Dec. 14, 2007 (JP) 2007-323580
Aug. 22, 2008 (JP) 2008-214414

(51) Int. Cl. G02F 1/1335

(52) U.S. Cl. 349/102

(57) ABSTRACT

An optical film for a multi-domain VA mode liquid crystal cell, capable of improving a luminance of white display at a low cost without reducing a display quality. The optical film 10 used for a multi-domain VA mode liquid crystal cell includes a transparent polymer film 11, a polarizer 12, and an optical compensation layer 14 laminated in this order. The optical film 10 further includes a λ/4 plate 13. The λ/4 plate 13 is arranged between the polarizer 12 and the optical compensation layer 14, and an angle between an absorption axis of the polarizer 12 and a slow axis of the λ/4 plate is set in the range of 45°±5°.

### TECHNICAL FIELD

The present invention relates to an optical film and a liquid crystal panel and a liquid crystal display using the same.

### BACKGROUND ART

Liquid crystal displays (LCDs) are devices that display characters and images utilizing electro-optical characteristics of liquid crystal molecules, and they are used widely in mobile phones, notebook computers, liquid crystal televisions, and the like. In a LCD, a liquid crystal panel having a polarizing plate arranged on each side of a liquid crystal cell generally is used. An example of the configuration of the liquid crystal cell is shown in the schematic sectional view of FIG. 4. As shown in FIG. 4, the liquid crystal cell 21 is configured so that spacers 212 are arranged between a pair of substrates 211, and a liquid crystal layer 213 is held in a space that is formed between the pair of substrates 211 by the spacers 212. Although not shown in the drawing, one of the substrates is provided with a switching element (for example, TFT) for controlling electro-optical characteristics of the liquid crystal molecule, a scanning line for supplying gate signals to the switching element, and a signal line for supplying source signals to the switching element. The vertical alignment (VA) mode is known as a drive mode of a liquid crystal cell used for a LCD. Since liquid crystal molecules of this VA mode liquid crystal cell are aligned almost vertically to the substrate plane in the non-driving state, light passes through a liquid crystal layer with its polarization plane substantially unchanged. Therefore, in the VA mode liquid crystal cell, almost perfect black display can be achieved in the non-driving state by arranging a polarizing plate on each of the upper and the lower sides of a substrate.

However, in a LCD using the VA mode liquid crystal cell, even though almost perfect black display can be achieved in the normal direction of a liquid crystal panel, when the liquid crystal panel is observed from a direction (an oblique direction) deviated from the normal direction, light leakage occurs by the influence of the birefringence of a liquid crystal layer. Thus, the LCD had a problem that its viewing angle becomes narrow.

In order to solve this problem, an optical compensation layer is arranged between a polarizing plate and a liquid crystal cell for the sake of compensating the birefringence of a liquid crystal layer that occurs in the case where a liquid crystal panel is observed from the oblique direction (for example, see Patent Document 1). However, even though this realizes a wider viewing angle of the LCD, a luminance of white display at the time of driving is not sufficient.

A multi-domain VA mode liquid crystal cell that realizes a wider viewing angle by tilting liquid crystal molecules in different directions at the time of applying a voltage is known. The multi-domain VA mode liquid crystal cell is characterized in that each pixel is divided into plural domains by tilting the liquid crystal molecules in four directions, namely, 45°, 135°, 225°, and 315° counterclockwise with respect to the longitudinal direction of the liquid crystal cell, for example. As above, by causing liquid crystal molecules aligning in the different directions to be present in the liquid crystal cell, a view is not limited to only a specific direction, whereby a wider viewing angle can be realized.

When all liquid crystal molecules can be tilted in the desired directions in the multi-domain VA mode liquid crystal cell, a luminance of white display becomes high. However, controlling all the liquid crystal molecules so as to tilt in the desired directions is substantially impossible. Therefore, part of linearly polarized light transmitted through the polarizer on the backlight side is trapped in the liquid crystal cell, so that a luminance of white display is reduced.

As a method for improving a luminance of white display of a LCD, there is a method in which a light quantity of a backlight is increased by, for example, increasing the number of cold-cathode tubes. However, in this method, components of a LCD are affected adversely by increasing the heating value of a backlight, and display quality is reduced.

Further, there is a method for improving a luminance of white display by using a brightness enhancement film in a LCD. However, the use of the brightness enhancement film involves the cost thereof.

Patent Document 1: JP 2004-46065 A

### BRIEF SUMMARY OF THE INVENTION

Hence, the present invention is intended to provide an optical film for a multi-domain VA mode liquid crystal cell, capable of improving a luminance of white display at a low cost without reducing a display quality and a liquid crystal panel and a liquid crystal display using the same.

In order to achieve the aforementioned object, the optical film of the present invention is an optical film used for a multi-domain VA mode liquid crystal cell, including: a transparent polymer film; a polarizer; and an optical compensation layer laminated in this order, wherein

the optical film further includes a λ/4 plate,

the λ/4 plate is arranged between the polarizer and the optical compensation layer, and

an angle between an absorption axis of the polarizer and a slow axis of the λ/4 plate is set in a range of 45°±5°.

The liquid crystal panel of the present invention is a liquid crystal panel including a liquid crystal cell and two optical films, wherein

the liquid crystal cell is of a multi-domain VA mode,

each of the two optical films is the optical film of the present invention, and

the two optical films are arranged on a visible side and a backlight side of the liquid crystal cell, respectively, with the optical compensation layer of each of the two optical films being on a liquid crystal cell side.

The liquid crystal display of the present invention is a liquid crystal display including a liquid crystal panel, wherein the liquid crystal panel is the liquid crystal panel of the present invention.

In order to achieve the aforementioned object, the inventors of the present invention carried out a series of studies. In a course of the studies, they found out that, in a multi-domain VA mode liquid crystal cell, a luminance of white display can be improved by converting light incident on the liquid crystal cell to circularly polarized light, even though some of liquid crystal molecules are tilted in directions that are deviated from the desired directions. In the optical film of the present invention, a λ/4 plate is arranged between a polarizer and an optical compensation layer, and an angle between an absorption axis of the polarizer and a slow axis of the λ/4 plate is set in the predetermined range. Therefore, by arranging the optical film of the present invention on the backlight side of the liquid crystal cell in the state where the optical compensation layer is on the liquid crystal cell side, linearly polarized light transmitted through the polarizer is converted to circularly polarized light by the λ/4 plate, and thereafter, the circularly polarized light is incident on the liquid crystal cell. Thus, it is considered that all polarized light is transmitted through the liquid crystal cell even though some of the liquid crystal molecules are tilted in the directions that are deviated from the desired directions in the liquid crystal cell. Further, by arranging the optical film of the present invention on the visible side of the liquid crystal cell in the state where the optical compensation layer is on the liquid crystal cell side, circularly polarized light transmitted through the liquid crystal cell is converted to linearly polarized light by the λ/4 plate, and thereafter, the linearly polarized light is transmitted through the polarizer. As above, by arranging the optical film of the present invention on each side of the liquid crystal cell, a luminance of white display of a liquid crystal display can be improved. It is to be noted that this mechanism by which the luminance of white display is improved is presumption, and the present invention is not at all limited by this mechanism. Further, according to the present invention, the luminance of white display can be improved without increasing the light quantity of a backlight, so that reduction in a display quality of a liquid crystal display due to the increase in amount of heat generated by the backlight is prevented. Furthermore, according to the present invention, there is no need to use members such as a brightness enhancement film and the like to improve a luminance of white display of a liquid crystal display. Thus, cost reduction can be achieved.

### BRIEF DESCRIPTION OF DRAWINGS

FIG. 1 is a schematic sectional view showing an example of the configuration of an optical film of the present invention.

FIG. 2 is a schematic sectional view showing an example of the configuration of a liquid crystal panel of the present invention.

FIG. 3 is a schematic sectional view showing an example of the configuration of a liquid crystal display of the present invention.

FIG. 4 is a schematic sectional view showing an example of the configuration of a liquid crystal cell.

### DETAILED DESCRIPTION OF THE INVENTION

In the optical film of the present invention, an in-plane retardation value Re of the λ/4 plate preferably is in the range of 90 to 180 nm.

In the optical film of the present invention, the optical compensation layer preferably has a refractive index distribution satisfying nx≧ny>nz. It is to be noted that the “nx≧ny>nz” means “at least one selected from nx=ny>nz and nx>ny>nz” in the present invention.

In the optical film of the present invention, the optical compensation layer preferably is formed of at least one non-liquid crystalline polymer selected from the group consisting of polyimides, polyamides, polyesters, polyaryletherketones, polyetherketones, polyamideimides, and polyesterimides.

In the optical film of the present invention, the optical compensation layer preferably is formed of at least one resin selected from the group consisting of norbornene resins, polycarbonate resins, and cellulose resins

In the optical film of the present invention, the λ/4 plate preferably is formed of at least one resin selected from the group consisting of norbornene resins, polycarbonate resins, cellulose resins, polyvinyl alcohol resins, and polysulfone resins

In the optical film of the present invention, the λ/4 plate and the optical compensation layer may be attached together through at least one of a pressure-sensitive adhesive layer and an adhesive layer.

In the liquid crystal panel of the present invention, the optical film on the visible side and the optical film on the backlight side preferably are arranged so that their absorption axes are orthogonal to each other.

Next, the optical film, the liquid crystal panel, and the liquid crystal display of the present invention will be described in detail with reference to examples.

[A. Definition and the Like]

In the present invention, an angle between an absorption axis of the polarizer and a slow axis of the λ/4 plate refers to a smaller one of two angles (a narrow angle) formed between the absorption axis of the polarizer and slow axis of the λ/4 plate.

In the present invention, a refractive index “nx” denotes a refractive index in a direction (a slow axis direction) in which an in-plane refractive index of a layer (a λ/4 plate, an optical compensation layer, and a liquid crystal cell, or the like, hereinafter the same) reaches its maximum. A refractive index “ny” denotes a refractive index in a direction (a fast axis direction) that is orthogonal to the nx direction within the plane of the layer. A refractive index “nz” denotes a refractive index in the thickness direction of the layer, which is orthogonal to each of the nx and ny directions.

In the present invention, an in-plane retardation value Re[λ] of the layer denotes an in-plane retardation value at a wavelength λ (nm) at 23° C. calculated by the equation: Re[λ]=(nx−ny)×d, for example. d denotes the thickness (nm) of the layer.

In the present invention, a retardation value Rth[λ] in the thickness direction of the layer denotes a retardation value at a wavelength λ (nm) at 23° C. calculated by the equation: Rth[λ]=(nx−nz)×d, for example. d denotes the thickness of the layer.

In the present invention, an Nz coefficient is a value obtained by calculation based on an equation: Nz coefficient=Rth[λ]/Re[λ]. λ can be set to 590 nm, for example.

In the present invention, a “λ/4 plate” refers to a plate having a function of converting linearly polarized light at a specific wavelength to circularly polarized light (or converting circularly polarized light to linearly polarized light). The λ/4 plate has an in-plane retardation value of the layer that is about one fourth of the in-plane retardation value of the layer to a predetermined wavelength of light (generally, in the visible light region). In the present invention, “nx=ny” or “ny=nz” not only means that they are completely the same, but also encompasses the case where they are substantially the same. Therefore, for example, when it is described that nx=ny, it encompasses the case where Re[590] is less than 10 nm.

In the present invention, the term “orthogonal” also encompasses the case of “substantially orthogonal”, which means, for example, the deviation is within the range of 90°±2°, preferably from 90°±1°. Also, in the present invention, the term “parallel” also encompasses the case of “substantially parallel”, which means, for example, the deviation is within the range of 0°±2°, preferably from 0°±1°.

[B. Optical Film of Present Invention]

[B-1. Overall Configuration of Optical Film of Present Invention]

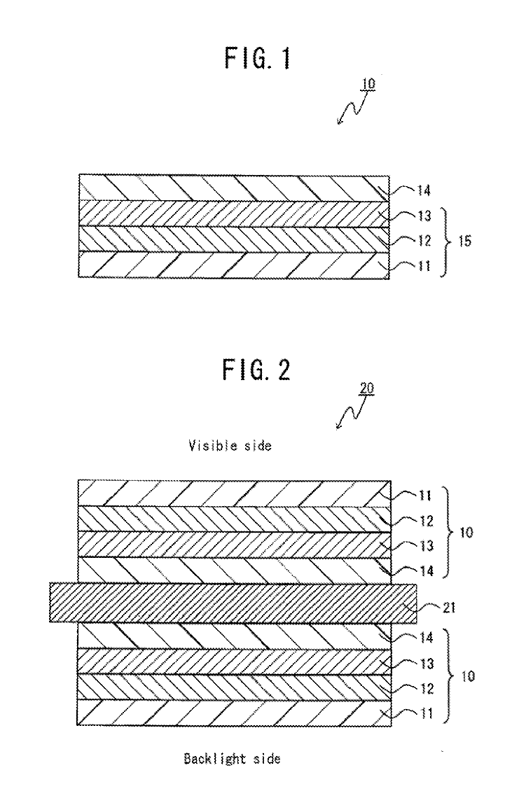

An example of the configuration of the optical film of the present invention is shown in the schematic sectional view of FIG. 1. In FIG. 1, the sizes, proportions, and the like of the respective components are different from the actual sizes, proportions, and the like for the sake of simplicity in illustration. As shown in FIG. 1, this optical film 10 is configured so that a transparent polymer film 11, a polarizer 12, a λ/4 plate 13, and an optical compensation layer 14 are laminated in this order. In the present example, the λ/4 plate 13 also serves as a protecting layer. A polarizing plate 15 is configured by the transparent polymer film 11, the polarizer 12, and the λ/4 plate 13. An angle between an absorption axis of the polarizer 12 and a slow axis of the λ/4 plate 13 is ideally 45°. However, the angle is substantially in the range of 45°±5°, preferably in the range of 45°±3°, and more preferably in the range of 45°±1°.

Between the respective components (the optical elements) of the optical film, an adhesive layer (not shown) or an optical element (preferably, one exhibiting isotropy) may be arranged optionally. The “adhesive layer” refers to a layer that joins the surfaces of adjacent optical elements and integrates them with sufficient adhesion strength within an acceptable adhesion time. Examples of the material for forming the adhesive layer include conventionally known adhesives, pressure-sensitive adhesives, and anchor coating agents. The adhesive layer may have a multilayer structure in which an anchor coating layer is formed on a surface of a substance to be joined and an adhesive layer is formed on the anchor coating layer. Furthermore, the adhesive layer may be a thin layer (also referred to as a hairline) that cannot be recognized with the naked eye.

The overall thickness of the optical film of the present invention is, for example, in the range of 50 to 1000 μm, preferably in the range of 80 to 500 μm, and more preferably in the range of 100 to 300 μm. According to the present invention, by arranging a λ/4 plate between a polarizer and an optical compensation layer and setting an angle between an absorption axis of the polarizer and a slow axis of the λ/4 plate in the predetermined range, a luminance of white display can be improved in a liquid crystal display using a multi-domain VA mode liquid crystal cell.

[B-2. Transparent Polymer Film]

The material for forming the transparent polymer film is not particularly limited. However, polymers having superior transparency are preferred. Examples of the material include acetate resins, polyester resins, polyethersulfone resins, polysulfone resins, polycarbonate resins, polyamide resins, polyimide resins, polyolefin resins, acrylic resins, polynorbornene resins, cellulose resins such as triacetyl cellulose (TAC), polyarylate resins, polystyrene resins, polyvinyl alcohol resins, polyvinyl chloride resins, polyvinylidene chloride resins, polyacrylic resins, and mixtures of these resins Further, liquid crystal polymers and the like also can be used. Furthermore, a mixture of a thermoplastic resin having a substituted imide group or a non-substituted imide group at the side chain and a thermoplastic resin having a substituted phenyl group or a non-substituted phenyl group and a nitrile group at the side chain, and the like as described in JP 2001-343529 A (WO 01/37007) also can be used, for example. A specific example thereof is, for example, a resin composite containing an alternating copolymer composed of isobutene and N-methylene maleimide and an acrylonitrile-styrene copolymer, or the like. Among these forming materials, materials with which transparent films whose birefringence can be set to be still relatively low are preferred. Specifically, the mixture of a thermoplastic resin having a substituted imide group or a non-substituted imide group at the side chain and a thermoplastic resin having a substituted phenyl group or a non-substituted phenyl group and a nitrile group at the side chain is preferred. Among the above-described resins, a cellulose polymer film such as TAC, a norbornene polymer film (for example, product name “ARTON” (manufactured by JSR Corporation), product name “ZEONOR” and product name “ZEONEX” (manufactured by ZEON CORPORATION), and the like) are typical examples.

The thickness of the transparent polymer film is, for example, in the range of 10 to 1000 μm, preferably in the range of 20 to 500 μm, and more preferably in the range of 30 to 100 μm.

[B-3. Polarizer]

The polarizer can be obtained by stretching a polymer film containing a polyvinyl alcohol resin that contains iodine, for example. The content of iodine in the polarizer is, for example, in the range of 1.8% to 5.0% by weight, preferably in the range of 2.0% to 4.0% by weight. The polarizer preferably further contains potassium. The content of potassium in the polarizer is, for example, in the range of 0.2% to 1.0% by weight, preferably in the range of 0.3% to 0.9% by weight, and more preferably in the range of 0.4% to 0.8% by weight. The polarizer preferably further contains boron. The content of boron in the polarizer is, for example, in the range of 0.5% to 3.0% by weight, preferably in the range of 1.0% to 2.8% by weight, and more preferably in the range of 1.5% to 2.6% by weight.

The polyvinyl alcohol resin can be obtained by, for example, saponifying a vinyl ester polymer that is obtained by polymerizing a vinyl ester monomer. The saponification degree of the polyvinyl alcohol resin preferably is in the range of 95.0% to 99.9% by mol. By using the polyvinyl alcohol resin with the saponification degree in the above-described range, it is possible to obtain a polarizer with a higher durability. With regard to the average polymerization degree of the polyvinyl alcohol resin, any suitable value can be selected as appropriate in accordance with the purpose of using the polyvinyl alcohol resin. The average polymerization degree preferably is in the range of 1200 to 3600. The average polymerization degree can be determined according to JIS K 6726 (1994 version), for example.

As a method of obtaining a polymer film containing the polyvinyl alcohol resin, any suitable processing method can be employed. Example of the processing method include the one described in [Example 1] of JP 2001-315144 A.

The polymer film containing the polyvinyl alcohol resin preferably contains at least one of a plasticizer and a surfactant. Examples of the plasticizer include polyhydric alcohols such as ethylene glycol and glycerin. Examples of the surfactant include nonionic surfactants. The content of the plasticizer and the surfactant preferably is in the range of 1 to 10 parts by weight with respect to 100 parts by weight of the polyvinyl alcohol resin. The plasticizer and the surfactant further enhance the dye-affinity and the stretchability of the polarizer, for example.

As the polymer film containing the polyvinyl alcohol resin, it is possible to use a commercially available film as it is, for example. Examples of the commercially available polymer film containing the polyvinyl alcohol resin include “KURARAY VINYLON FILM (product name)” manufactured by Kuraray Co., Ltd., “TOHCELLO VINYLON FILM (product name)” manufactured by Tohcello Co., Ltd., and “NICHIGO VINYLON FILM (product name)” manufactured by Nippon Synthetic Chemical Industry Co., Ltd.

[B-4. λ/4 Plate]

The in-plane retardation value Re of the λ/4 plate is preferably in the range of 90 to 180nm, more preferably in the range of 100 to 160 nm, and yet more preferably in the range of 120 to 150 nm.

The thickness of the λ/4 plate is, for example, in the range of 10 to 100 μm, preferably in the range of 20 to 80 μm, and more preferably in the range of 30 to 60 μm.

The λ/4 plate can be formed by subjecting a polymer film to a stretching treatment, for example. Aλ/4 plate having desired optical characteristics (for example, a refractive index distribution, an in-plane retardation value, a retardation value in a thickness direction, and a Nz coefficient) can be formed by selecting the type of the polymer, stretching conditions (for example, a stretching temperature, a stretch ratio, and a stretching direction), a stretching method, and the like appropriately, for example. More specifically, the stretching temperature is, for example, in the range of 120° C. to 180° C., preferably in the range of 140° C. to 170° C. The stretch ratio is, for example, in the range of 1.05 to 2.0 times, preferably in the range of 1.3 to 1.6 times. The stretching method can be, for example, a transverse uniaxial stretching method. The stretching direction preferably is a direction substantially orthogonal to an absorption axis of the polarizer (a width direction of the polymer film, i.e., a direction orthogonal to a longitudinal direction).

As a polymer composing the polymer film, any suitable polymer may be used. Examples of the polymer include positive-birefringent films such as norbornene polymers, polycarbonate polymers, cellulose polymers, polyvinyl alcohol polymers, and polysulfone polymers. Among these polymers, norbornene polymers and polycarbonate polymers are preferred.

[B-5. Optical Compensation Layer]

As mentioned above, the optical compensation layer preferably has a refractive index distribution satisfying nx≧ny>nz. The optical compensation layer may be a single layer or a laminate of a plurality of layers. In the present invention, the thickness of the optical compensation layer is not particularly limited, and is preferably in the range of 0.1 to 50 μm, more preferably in the range of 0.5 to 30 μm, and yet more preferably in the range of 1 to 20 μm because this allows the thickness of a liquid crystal display to be reduced and an optical film having a superior viewing angle compensation function and uniform retardation to be provided.

Example of the material for forming the optical compensation layer includes the following two types of materials.

One is a non-liquid crystalline polymer type. An optical compensation layer having a refractive index distribution satisfying nx=ny>nz (optical uniaxiality) can be formed by, for example, forming a film by applying the non-liquid crystalline polymer (hereinafter, referred to as “coating film”) on the surface of the λ/4 plate on the side opposite to the transparent polymer film side and solidifying the non-liquid crystalline in the coating film. Alternatively, an optical compensation layer having a refractive index distribution satisfying nx>ny>nz (optical biaxiality) can be formed by, for example, forming a coating film by applying the non-liquid crystalline polymer to a base that is different from the λ/4 plate, shrinking or stretching the base and the coating film together, and attaching them to the λ/4 plate through a pressure-sensitive adhesive layer or an adhesive layer. In the latter case, the base, which is different from the λ/4 plate, may be removed from the optical compensation layer after being attached to the λ/4 plate, or may be left as it is without removing.

The other is a film type. An optical compensation layer having a refractive index distribution satisfying nx=ny>nz (optical uniaxiality) can be formed by, for example, subjecting a film containing a norbornene resin, a polycarbonate resin, a cellulose resin, or the like to uniaxial stretching. Alternatively, an optical compensation layer having a refractive index distribution satisfying nx>ny>nz (optical biaxiality) can be formed by, for example, subjecting the film to biaxial stretching.

[B-5-1. Non-Liquid Crystalline Polymer Type]

First, the non-liquid crystalline polymer type will be described. The non-liquid crystalline polymer preferably is, for example, polyimide, polyamide, polyester, polyaryletherketone, polyetherketone, polyamideimide, polyesterimide, or the like because of its superior heat resistance, chemical resistance, transparency, and rigidity. These polymers may be used alone or as a mixture of two or more of them having different functional groups, such as, for example, a mixture of polyaryletherketone and polyamide. Among such polymers, polyimide is particularly preferred because of its high transparency, a high alignment property, and high stretchability. The molecular weight of the polymer is not particularly limited, and the weight-average molecular weight (Mw) of the polymer is, for example, preferably in the range of 1,000 to 1,000,000, more preferably in the range of 2,000 to 500,000. The weight-average molecular weight can be, for example, measured by a gel permeation chromatography (GPC) using polyethylene oxide as a standard sample and DMF (N,N-dimethylformamide) as a solvent.

As the polyimide, for example, it is preferable to use a polyimide that has a high in-plane alignment property and is soluble in organic solvents. Specifically, it is possible to use a polymer containing a polycondensation product of 9,9-bis(aminoaryl)fluorene and aromatic tetracarboxylic acid dianhydride disclosed in JP 2000-511296 A and having one or more repeating units represented by the following formula (1).

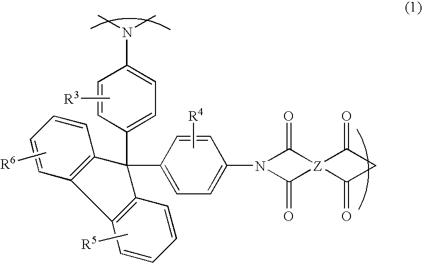

In the formula (1), R³ to R⁶ are each at least one substituent selected independently from the group consisting of hydrogen, halogens, a phenyl group, phenyl groups substituted with one to four halogen atoms or C₁ to C₁₀ alkyl groups, and C₁ to C₁₀ alkyl groups. Preferably, R³ to R⁶ are each at least one substituent selected independently from the group consisting of halogens, a phenyl group, phenyl groups substituted with one to four halogen atoms or C₁ to C₁₀ alkyl groups, and C₁ to C₁₀ alkyl groups.

In the formula (1), Z is, for example, a C₆ to C₂₀ quadrivalent aromatic group, preferably a pyromellitic group, a polycyclic aromatic group, a derivative of the polycyclic aromatic group, or a group represented by the following formula (2).

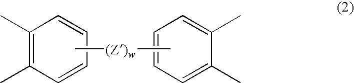

In the formula (2), Z′ is, for example, a covalent bond, a C(R⁷)₂ group, a CO group, an O atom, a S atom, a SO₂ group, a Si(C₂H₅)₂ group, or a NR⁸ group. When there are plural Zs, they are identical to or different from each other. w denotes an integer from 1 to 10. R′s are each independently hydrogen or a C(R⁹)₃ group. R⁸ is hydrogen, an alkyl group with a carbon atom number of 1 to about 20, or a C₆ to C₂₀ aryl group. When there are plural R⁸s, they are identical to or different from each other. R⁹s are each independently hydrogen, fluorine, or chlorine.

Examples of the polycyclic aromatic group include quadrivalent groups derived from naphthalene, fluorene, benzofluorene, and anthracene. Examples of the substituted derivative of the polycyclic aromatic group include the polycyclic aromatic groups substituted with at least one group selected from the group consisting of C₁ to C₁₀ alkyl groups, fluorinated derivatives of the C₁ to C₁₀ alkyl groups, and halogens such as fluorine and chlorine.

Besides these polyimides, examples of the polyimide include homopolymers having a repeating unit represented by the following general formula (3) or (4) described in JP 8(1996)-511812 A and polyimides whose repeating units are represented by the following general formula (5). It is to be noted that the polyimides represented by the following general formula (5) are preferred forms of the homopolymers represented by the following general formula (3).

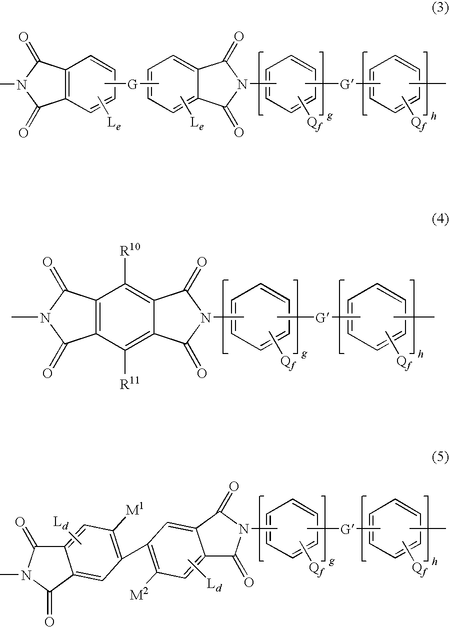

In the above general formulae (3) to (5), G and G′ each are a group selected independently from the group consisting of a covalent bond, a CH₂ group, a C(CH₃)₂ group, a C(CF₃)₂ group, a C(CX₃)₂ group (where X is halogen), a CO group, an O atom, an S atom, an SO₂ group, an Si(CH₂CH₃)₂ group, and an N(CH₃) group, and G and G′ may be identical to or different from each other.

In the above general formulae (3) and (5), L is a substituent, and d and e denote the number of substituents, respectively. L is, for example, a halogen, a C₁ to C₃ alkyl group, a halogenated C₁ to C₃ alkyl group, a phenyl group, or a substituted phenyl group, and when there are plural Ls, they are identical to or different from each other. The substituted phenyl group can be, for example, a substituted phenyl group having at least one substituent selected from the group consisting of halogens, C₁ to C₃ alkyl groups, and halogenated C₁ to C₃ alkyl groups. Examples of the halogen include fluorine, chlorine, bromine, and iodine. d is an integer from 0 to 2, and e is an integer from 0 to 3.

In the above general formulae (3) to (5), Q is a substituent, and f denotes the number of substituents therein. Q is, for example, an atom or a group selected from the group consisting of hydrogen, halogens, alkyl groups, substituted alkyl groups, a nitro group, a cyano group, thioalkyl groups, alkoxy groups, aryl groups, substituted aryl groups, alkyl ester groups, and substituted alkyl ester groups. When there are plural Qs, they are identical to or different from each other. Examples of the halogen include fluorine, chlorine, bromine, and iodine. Examples of the substituted alkyl group include halogenated alkyl groups. Examples of the substituted aryl group include halogenated aryl groups. f is an integer from 0 to 4, g is an integer from 0 to 3, and h is an integer from 1 to 3. Preferably, g and h are more than 1.

In the above formula (4), R¹⁰ and R¹¹ each are a group selected independently from the group consisting of hydrogen, halogens, a phenyl group, substituted phenyl groups, alkyl groups, and substituted alkyl groups. Among them, it is preferable that R¹⁰ and R¹¹ are each independently a halogenated alkyl group.

In the above formula (5), M¹ and M² are identical to or different from each other, and examples thereof include halogens, C₁ to C₃ alkyl groups, halogenated C₁ to C₃ alkyl groups, a phenyl group, and substituted phenyl groups. Examples of the halogen include fluorine, chlorine, bromine, and iodine. The substituted phenyl group can be, for example, a substituted phenyl group having at least one substituent selected from the group consisting of halogens, C₁ to C₃ alkyl groups, and halogenated C₁ to C₃ alkyl groups.

Examples of the polyimide represented by the above formula (3) include the one represented by the following chemical formula (6), for example.

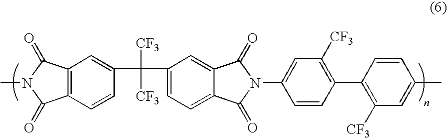

Further, the polyimide can be, for example, a copolymer obtained by copolymerizing acid dianhydride or diamine other than the skeletons (the repeating units) such as mentioned above in an appropriate manner.

Examples of the acid dianhydride includes aromatic tetracarboxylic acid dianhydrides. Examples of the aromatic tetracarboxylic acid dianhydride include pyromellitic acid dianhydride, benzophenone tetracarboxylic acid dianhydride, naphthalene tetracarboxylic acid dianhydride, heterocyclic aromatic tetracarboxylic acid dianhydride, and 2,2′-substituted biphenyltetracarboxylic acid dianhydride.

Examples of the pyromellitic acid dianhydride include pyromellitic acid dianhydride, 3,6-diphenyl pyromellitic dianhydride, 3,6-bis(trifluoromethyl)pyromellitic dianhydride, 3,6-dibromo pyromellitic dianhydride, and 3,6-dichloro pyromellitic dianhydride. Examples of the benzophenone tetracarboxylic acid dianhydride include 3,3′,4,4′-benzophenone tetracarboxylic acid dianhydride, 2,3,3′,4′-benzophenone tetracarboxylic acid dianhydride, and 2,2′,3,3′-″benzophenone tetracarboxylic acid dianhydride. Examples of the naphthalene tetracarboxylic acid dianhydride include 2,3,6,7-naphthalene-tetracarboxylic acid dianhydride, 1,2,5,6-naphthalene-tetracarboxylic acid dianhydride, and 2,6-dichloro-naphthalene-1,4,5,8-tetracarboxylic acid dianhydride. Examples of the heterocyclic aromatic tetracarboxylic acid dianhydride include thiophene-2,3,4,5-tetracarboxylic acid dianhydride, pyrazine-2,3,5,6-tetracarboxylic acid dianhydride, and pyridine-2,3,5,6-tetracarboxylic acid dianhydride. Examples of the 2,2′-substituted biphenyltetracarboxylic acid dianhydride include 2,2′-dibromo-4,4′,5,5′-biphenyltetracarboxylic acid dianhydride, 2,2′-dichloro-4,4′,5,5′-biphenyltetracarboxylic acid dianhydride, and 2,2′-bis(trifluoromethyl)-4,4′,5,5′-biphenyltetracarboxylic acid dianhydride.

Other examples of the aromatic tetracarboxylic acid dianhydride include 3,3′,4,4′-biphenyltetracarboxylic acid dianhydride, bis(2,3-dicarboxyphenyl)methane dianhydride, bis(2,5,6-trifluoro-3,4-dicarboxyphenyl)methane dianhydride, 2,2-bis(3,4-dicarboxyphenyl)-1,1,1,3,3,3-hexafluoropropane dianhydride, 4,4′-(3,4-dicarboxyphenyl)-2,2-diphenylpropane dianhydride, bis(3,4-dicarboxyphenyl)ether dianhydride, 4,4′-oxydiphthalic acid dianhydride, bis(3,4-dicarboxyphenyl)sulfonic acid dianhydride (3,3′,4,4′-diphenylsulfone tetracarboxylic acid dianhydride), 4,4′-[4,4′-isopropylidene-di(p-phenyleneoxy)]bis(phthalic acid anhydride), N,N-(3,4-dicarboxyphenyl)-N-methylamine dianhydride, and bis(3,4-dicarboxyphenyl)diethylsilane dianhydride.

Among these aromatic tetracarboxylic dianhydrides, the aromatic tetracarboxylic acid dianhydride is preferably 2,2′-substituted biphenyltetracarboxylic acid dianhydride, more preferably 2,2′-bis(trihalomethyl)-4,4′,5,5′-biphenyltetracarboxylic acid dianhydride, and yet more preferably 2,2′-bis(trifluoromethyl)-4,4′,5,5′-biphenyltetracarboxylic acid dianhydride.

Examples of the diamine include aromatic diamines, and examples thereof include benzenediamines, diaminobenzophenones, naphthalenediamines, heterocyclic aromatic diamines, and other aromatic diamines.

Examples of the benzenediamine include o-, m-, and p-phenylenediamines, 2,4-diaminotoluene, 1,4-diamino-2-methoxybenzene, 1,4-diamino-2-phenylbenzene, and 1,3-diamino-4-chlorobenzene. Examples of the diaminobenzophenone include 2,2′-diaminobenzophenone, and 3,3′-diaminobenzophenone. Examples of the naphthalenediamine include 1,8-diaminonaphthalene and 1,5-diaminonaphthalene. Examples of the heterocyclic aromatic diamine include 2,6-diaminopyridine, 2,4-diaminopyridine, and 2,4-diamino-S-triazine.

Examples of the other aromatic diamine include 4,4′-diaminobiphenyl, 4,4′-diaminodiphenylmethane, 4,4′-(9-fluorenylidene)-dianiline, 2,2′-bis(trifluoromethyl)-4,4′-diaminobiphenyl, 3,3′-dichloro-4,4′-diaminodiphenylmethane, 2,2′-dichloro-4,4′-diaminobiphenyl, 2,2′,5,5′-tetrachlorobenzidine, 2,2-bis(4-aminophenoxyphenyl)propane, 2,2-bis(4-aminophenyl)propane, 2,2-bis(4-aminophenyl)-1,1,1,3,3,3-hexafluoropropane, 4,4′-diaminodiphenylether, 3,4′-diaminodiphenylether, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis[4-(4-aminophenoxy)phenyl]propane, 2,2-bis[4-(4-aminophenoxy)phenyl]-1,1,1,3,3,3-hexafluoropropane, 4,4′-diaminodiphenylthioether, and 4,4′-diaminodiphenylsulfone.

The polyetherketone that is a material for forming the optical compensation layer can be, for example, polyaryletherketone represented by the following general formula (7) that is described in JP 2001-49110 A.

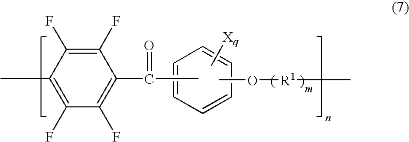

In the general formula (7), X denotes a substituent, and q denotes the number of substituents therein. X is, for example, a halogen atom, a lower alkyl group, a halogenated alkyl group, a lower alkoxy group, or a halogenated alkoxy group. When there are plural Xs, they are identical to or different from each other.

Examples of the halogen atom include a fluorine atom, a bromine atom, a chlorine atom, and an iodine atom, and among them, the fluorine atom is preferred. The lower alkyl group is, for example, preferably a straight-chain or branched-chain C₁ to C₆ lower alkyl group, more preferably a straight-chain or branched-chain C₁ to C₄ alkyl group. Specifically, a methyl group, an ethyl group, a propyl group, an isopropyl group, a butyl group, an isobutyl group, a sec-butyl group, and a tert-butyl group are preferred, and the methyl group and the ethyl group are particularly preferred. Examples of the halogenated alkyl group include halides of the lower alkyl groups such as a trifluoromethyl group. The lower alkoxy group is, for example, preferably a straight-chain or branched-chain C₁ to C₆ alkoxy group, more preferably a straight-chain or branched-chain C₁ to C₄ alkoxy group. Specifically, a methoxy group, an ethoxy group, a propoxy group, an isopropoxy group, a butoxy group, an isobutoxy group, a sec-butoxy group, and a tert-butoxy group are yet more preferred, and the methoxy group and the ethoxy group are particularly preferred. Examples of the halogenated alkoxy group include halides of the lower alkoxy groups such as a trifluoromethoxy group.

In the above general formula (7), q is an integer from 0 to 4. In the general formula (7), it is preferable to satisfy q=0, and a carbonyl group and an oxygen atom of an ether that are bounded to both ends of a benzene ring are present at para positions.

Further, in the above general formula (7), R¹ is a group represented by the following formula (8), and m is an integer of 0 or 1.

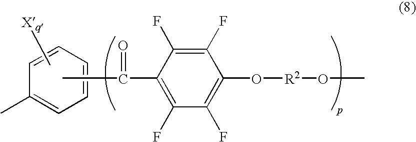

In the above formula (8), X′ denotes a substituent, and is, for example, the same as X in the general formula (7). In the formula (8), when there are plural X′s, they are identical to or different from each other. q′ denotes the number of X′ substituents. q′ is an integer from 0 to 4, and preferably satisfies q′=0. p is an integer of 0 or 1.

In the formula (8), R² denotes a divalent aromatic group. Examples of this divalent aromatic group include o-, m-, and p-phenylene groups and divalent groups derived from naphthalene, biphenyl, anthracene, o-, m-, and p-terphenyls, phenanthrene, dibenzofuran, biphenylether, and biphenyl sulfone. In these divalent aromatic groups, hydrogen directly binding to aromatic may be substituted with a halogen atom, a lower alkyl group, or a lower alkoxy group. Among these aromatic groups, R² preferably is an aromatic group selected from the group consisting of aromatic groups represented by the following formulae (9) to (15).

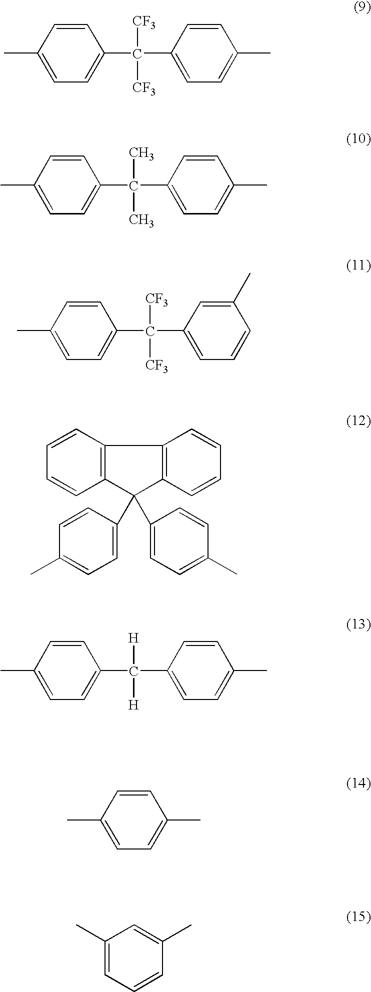

In the general formula (7), the R¹ preferably is a group represented by the following formula (16). In the formula (16), R² and p are the same as those in the formula (8).

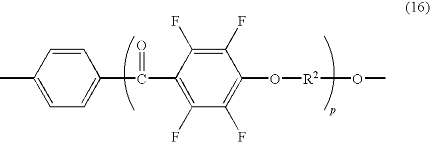

Further, in the general formula (7), n denotes a polymerization degree, and is, for example, in the range of 2 to 5000, preferably in the range of 5 to 500. The polymerization product may be composed of repeating units having the same structure, or may be composed of repeating units having different structures from each other. In the latter case, the polymerization form of the repeating units may be block polymerization or random polymerization.

Furthermore, in the ends of polyaryletherketone represented by the general formula (7), it is preferable that the end on a p-tetrafluorobenzoylene group side is fluorine, and the end on an oxyalkylene group side is a hydrogen atom. Such polyarylketone can be, for example, represented by the following general formula (17). It is to be noted that, in the following general formula (17), n denotes a polymerization degree that is the same as that in the general formula (7).

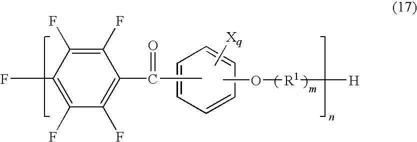

Examples of the polyaryletherketone represented by the general formula (7) include those represented by the following formulae (18) to (21). In the following formulae (18) to (21), n denotes a polymerization degree that is the same as that in the general formula (7).

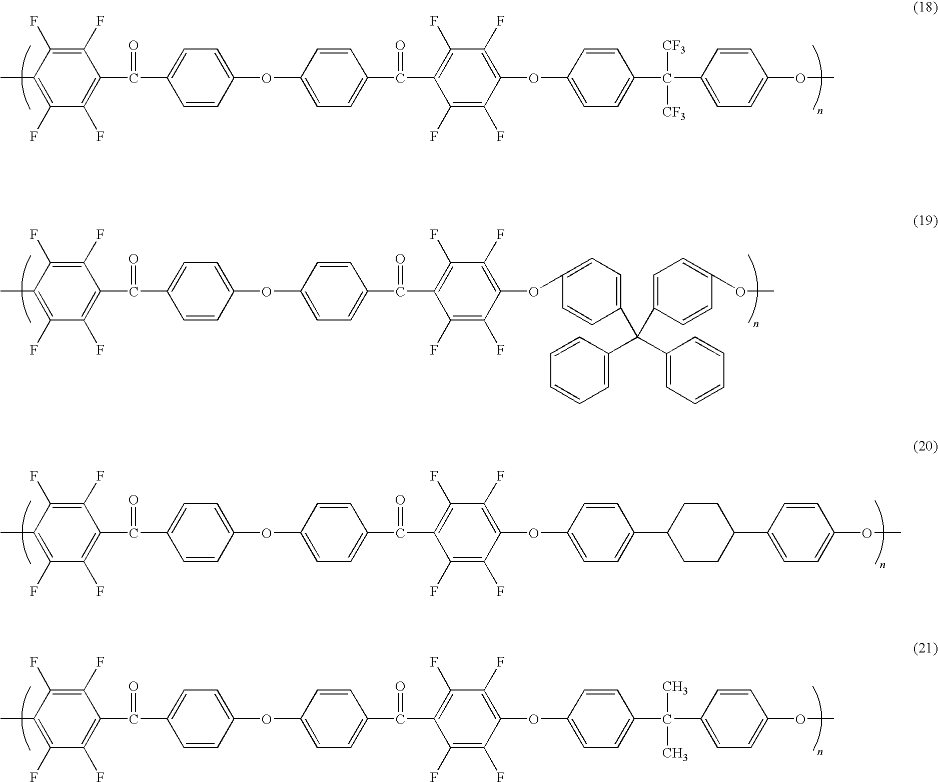

Besides theses materials, the polyamide or the polyester as a material for forming the optical compensation layer can be, for example, polyamide or polyester described in JP 10(1998)-508048 A, and the repeating unit thereof can be, for example, represented by the following general formula (22).

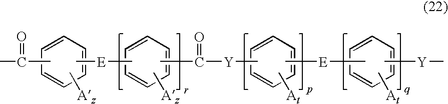

In the general formula (22), Y is O or NH. E is, for example, at least one group selected from the group consisting of a covalent bond, a C₂ alkylene group, halogenated C₂ alkylene groups, a CH₂ group, a C(CX₃)₂ group (where X is halogen or hydrogen), a CO group, an O atom, a S atom, a SO₂ group, Si(R)₂ groups, and N(R) groups, and may be identical to or different from each other. In the E, R is at least one of C₁ to C₃ alkyl groups and halogenated C₁ to C₃ alkyl groups, and is at a meta position or a para position to the carbonyl functional group or the Y group.

In the general formula (22), A and A′ are substituents. t denotes the number of A substituents, and z denotes the number of A′ substituents. p is an integer from 0 to 3, q is an integer from 1 to 3, and r is an integer from 0 to 3.

A is, for example, selected from the group consisting of hydrogen, halogens, C₁ to C₃ alkyl groups, halogenated C₁ to C₃ alkyl groups, alkoxy groups represented by OR (where R is as defined above), aryl groups, substituted aryl groups obtained by halogenation or the like, C₁ to C₉ alkoxy carbonyl groups, C₁ to C₉ alkylcarbonyloxy groups, C₁ to C₁₂ aryloxycarbonyl groups, C₁ to C₁₂ arylcarbonyloxy groups, substituted derivatives of the C₁ to C₁₂ arylcarbonyloxy groups, C₁ to C₁₂ arylcarbamoyl groups, C₁ to C₁₂ arylcarbonylamino groups, and substituted derivatives of the C₁ to C₁₂ aryl carbonylamino groups. When there are plural As, they are identical to or different from each other. A′ is, for example, selected from the group consisting of halogens, C₁ to C₃ alkyl groups, halogenated C₁ to C₃ alkyl groups, a phenyl group, and substituted phenyl groups, and when there are plural A's, they are identical to or different from each other. Examples of the substituent on a phenyl ring of the substituted phenyl group include halogens, C₁ to C₃ alkyl groups, halogenated C₁ to C₃ alkyl groups, and combinations thereof. t is an integer from 0 to 4, and z is an integer from 0 to 3.

Among the repeating units of the polyamide or polyester represented by the general formula (22), a repeating unit represented by the following general formula (23) is preferred.

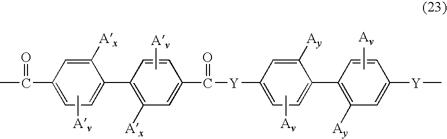

In the general formula (23), A, A′, and Y are as defined in the formula (22), and v is an integer from 0 to 3, preferably an integer from 0 to 2. Although each of x and y is 0 or 1, not both of them are 0.

As mentioned above, the optical compensation layer can be formed on a base by forming a coating film by applying the non-liquid crystalline polymer on the base and solidifying the non-liquid crystalline polymer in the coating film. The non-liquid crystalline polymer such as polyimide exhibits an optical characteristic of nx=ny>nz regardless of the presence or absence of alignment of the base because of the property of the non-liquid crystalline polymer. Therefore, an optical compensation layer having optical uniaxiality, i.e., having retardation in only the thickness direction, can be formed. It is to be noted that the optical compensation layer may be used by removing it from the base or in the state where it is formed on a base.

At the time of forming an optical compensation layer, the λ/4 plate preferably is used as the base. The reason for this is that, when the non-liquid crystalline polymer is applied directly on the λ/4 plate as a base, laminating the λ/4 plate and the optical compensation layer with a pressure-sensitive adhesive, an adhesive, or the like becomes unnecessary, so that the number of layers included in the optical film can be reduced. As a result, the optical film can be made even thinner and also the process of producing the optical film can be even more simplified.

Further, since the non-liquid crystalline polymer has a property of exhibiting optical uniaxiality as mentioned above, there is no need to utilize an alignment property of a base. Therefore, both of an alignment base and a non-alignment base can be used as the base. As the alignment base, a stretched film or the like can be used, and also one whose refractive index in the thickness direction is controlled or the like can be used. The refractive index can be controlled by, for example, a method in which a polymer film is attached to a heat-shrinkable film, and the resultant film is further heat-stretched, or the like.

The method for applying the non-liquid crystalline polymer on the base is not particularly limited, and examples of the method include a method for applying a non-liquid crystalline polymer such as mentioned above by heat-melting and a method for applying a polymer solution obtained by solving the non-liquid crystalline polymer in a solvent. Among the methods, the method for applying a polymer solution is preferred because of its superior operability.

The concentration of the polymer in the polymer solution is not particularly limited. However, for example, because the viscosity with which applying becomes easy can be obtained, the concentration of the non-liquid crystalline polymer preferably is in the range of 5 to 50 parts by weight, more preferably in the range of 10 to 40 parts by weight, with respect to 100 parts by weight of a solvent.

The solvent of the polymer solution is not particularly limited as long as the solvent can solve the non-liquid crystalline polymer and can be selected as appropriate depending on the type of the non-liquid crystalline polymer. Examples of the solvent include: halogenated hydrocarbons such as chloroform, dichloromethane, tetrachloromethane, dichloroethane, tetrachloroethane, trichloroethylene, tetrachloroethylene, chlorobenzene, and ortho-dichlorobenzene; phenols such as phenol and parachlorophenol; aromatic hydrocarbons such as benzene, toluene, xylene, methoxybenzene, and 1,2-dimethoxybenzene; ketone solvents such as acetone, methyl ethyl ketone (MEK), methyl isobutyl ketone (MIBK), cyclohexanone, cyclopentanone, 2-pyrrolidone, and N-methyl-2-pyrrolidone; ester solvents such as ethyl acetate and butyl acetate; alcohols such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide solvents such as dimethylformamide and dimethylacetamide; nitrile solvents such as acetonitrile and butyronitrile; ether solvents such as diethyl ether, dibutyl ether, and tetrahydrofuran; carbon disulfide; ethyl cellosolve; and butyl cellosolve. These solvents may be used alone or in a combination of two or more of them.

The polymer solution may further contain any appropriate additive. Examples of the additive include plasticizers, thermostabilizers, light stabilizers, lubricants, antioxidants, UV absorbers, flame retardants, colorants, antistatic agents, compatibilizers, crosslinking agents, thickeners, and metals.

The polymer solution may contains other different resins in the range where an alignment property or the like of the non-liquid crystalline polymer is not significantly reduced, for example. Examples of the resin include various general-purpose resins, engineering plastics, thermoplastic resins, and thermosetting resins.

Examples of the general-purpose resin include polyethylenes (PEs), polypropylenes (PPs), polystyrenes (PSs), polymethyl methacrylates (PMMAs), ABS resins, and AS resins Examples of the engineering plastics include polyacetates (POMs), polycarbonates (PCs), polyamides (PAs: nylons), polyethylene terephthalates (PETs), and polybutylene terephthalates (PBTs). Examples of the thermoplastic resin include polyphenylsulfides (PPSs), polyethersulfones (PESs), polyketones (PKs), polyimides (PIs), poly cyclohexanedimethanol terephthalates (PCTs), polyarylates (PARs), and liquid crystalline polymers (LCPs). Examples of the thermosetting resin include epoxy resins and phenol novolac resins

As above, when the other resins and the like are mixed in the polymer solution, the mixing amount is, for example, in the range of 0% to 50% by weight, preferably in the range of 0% to 30% by weight, with respect to the polymer material, for example.

Examples of the method for applying the polymer solution include a spin coating method, a roller coating method, a flow coating method, a printing method, a clip coating method, a film casting method, a bar coating method, and gravure printing method. It is to be noted that, at the time of applying, a method for superimposing a polymer layer can be employed as necessary.

Solidification of the non-liquid crystalline polymer forming a coating film can be carried out by, for example, drying the coating film. The drying method is not particularly limited, and can be, for example, air drying or heat drying. The drying conditions can be, for example, selected as appropriate depending on the types of the non-liquid crystalline polymer and the solvent and the like. The drying temperature is, for example in the range of 40° C. to 300° C., preferably in the range of 50° C. to 250° C., and more preferably in the range of 60° C. to 200° C. It is to be noted that the drying of the coating film may be carried out at a constant temperature or by gradually increasing or decreasing the temperature. The drying time also is not particularly limited, and is, for example, in the range of 10 seconds to 30 minutes, preferably in the range of 30 seconds to 25 minutes, and more preferably in the range of 1 to 20 minutes.

A solvent of the polymer solution remaining in the optical compensation layer may cause optical characteristics of the optical film to change over time in proportion to the amount of the remaining solvent. Therefore, the remaining amount is, for example, preferably 5% or less, more preferably 2% or less, and more preferably 0.2% or less.

An optical compensation layer having optical biaxiality, i.e., a refractive index distribution satisfying nx>ny>nz, can be formed also by using a base that is different from the λ/4 plate as the base. Specifically, for example, a coating film is formed by directly applying the non-liquid crystalline polymer on a base that is shrinkable in one direction within a plane in the same manner as mentioned above, and thereafter, the base is shrunk. As the base is shrunk, the coating film on the base also is shrunk in the plane direction. Therefore, the differences among refractive indices are generated within a plane in the coating film, whereby optical biaxiality (nx>ny>nz) is exhibited. The optical compensation layer having optical biaxiality is formed by solidifying the non-liquid crystalline polymer forming the coating film.

To cause the base to be shrinkable in one direction within a plane, it is preferable that the base is previously stretched in one direction within a plane, for example. By previously stretching the base as above, shrinkage force is generated in the direction opposite to the stretching direction. Utilizing the difference in shrinkage within a plane of this base, the non-liquid crystalline forming the coating film is caused to have the differences among refractive indices within a plane. The thickness of the base before the stretching is not particularly limited, and is, for example, in the range of 10 to 200 μm, preferably in the range of 20 to 150 μm, and more preferably in the range of 30 to 100 μm. The stretch ratio is not particularly limited.

The base can be shrunk by forming a coating film on the base in the same manner as mentioned above and thereafter heat-treating the base. The conditions of the heat treatment are not particularly limited, and can be, for example, selected as appropriate depending on the type of the material of the base. The heating temperature is, for example, in the range of 25° C. to 300° C., preferably in the range of 50° C. to 200° C., and more preferably in the range of 60° C. to 180° C. The extent of the shrinkage is not particularly limited. The shrink ratio can be, for example, more than 0% and 10% or less, assuming that the length of the base before shrinking is 100%.

On the other hand, an optical compensation layer having optical biaxiality, i.e., satisfying nx>ny>nz, can be formed on a base also by forming a coating film on a base that is different from the λ/4 plate in the same manner as mentioned above and stretching the base and the coating film together. According to this method, by stretching a laminate of the base and the coating film together in one direction within a plane, the differences among refractive indices are generated within a plane of the coating film, and the optical compensation layer is caused to have optical biaxiality (nx>ny>nz).

The method for stretching the laminate of the base and the coating film is not particularly limited, and examples thereof include free-end longitudinal stretching that performs uniaxial stretching in the longitudinal direction, fixed-end transverse stretching that performs uniaxial stretching in the width direction in the state where a film is fixed in the longitudinal direction, sequential or simultaneous biaxial stretching that performs stretching in both of the longitudinal direction and the width direction.

The stretching of the laminate is carried out by stretching both of the base and the coating film. However, stretching only the base is preferred for the following reason. When the base only is stretched, the coating film on the base is indirectly stretched by the tension generated in the base by this stretching. Further, since uniform stretching generally is achieved by the stretching of a single layer rather than by the stretching of a laminate, the coating film on the base also can be stretched uniformly by stretching only the base uniformly as mentioned above.

The stretching conditions are not particularly limited, and can be selected as appropriate depending on, for example, the types of the base and the non-liquid crystalline polymer and the like. The heating temperature at the time of stretching can be selected as appropriate depending on, for example, the types of the base and the non-liquid crystalline polymer, their glass transition temperatures (Tg), the type of additives, and the like. The temperature is, for example, in the range of 80° C. to 250° C., more preferably in the range of 120° C. to 220° C., and yet more preferably in the range of 140° C. to 200° C. Particularly preferably, the temperature is around Tg of the material of the base or the Tg or higher. The Tg is, for example, a value calculated by differential scanning calorimetry (DSC) method according to JIS K 7121.

As above, an optical compensation layer having a refractive index distribution satisfying nx>ny>nz (optical biaxiality) can be formed by forming the coating film on a base that is different from the λ/4 plate, shrinking or stretching the base and the coating film together, and thereafter attaching them to the λ/4 plate through a pressure-sensitive layer or an adhesive layer. In this case, the base that is different from the λ/4 plate may be removed from the optical compensation layer after the attachment, or may be left as it is.

The pressure-sensitive adhesive or the adhesive is not particularly limited, and for example, it is possible to use conventionally known pressure-sensitive adhesives or adhesives such as transparent pressure-sensitive adhesives or adhesives such as acrylic, silicon, polyester, polyurethane, polyether, rubber pressure-sensitive adhesives or adhesives. Among them, from the viewpoint of preventing a change in optical characteristic of the optical film, those that do not require a process at high temperature when hardening or drying them are preferred, and specifically, acrylic pressure-sensitive adhesives that do not require a long time for a solidification treatment and drying are desired.

The optical compensation layer of the present invention particularly preferably is an optical compensation layer of a non-liquid crystalline polymer type that is formed of a non-liquid crystalline polymer such as the above-described polyamide. The reason for this is that, since the wavelength dispersion of the optical compensation layer of a non-liquid crystalline polymer type has a positive dispersion characteristic, which is similar to the positive dispersion characteristic of a multi-domain VA mode liquid crystal cell, a liquid crystal panel and a liquid crystal display each having a superior display characteristic can be obtained.

[B-5-2. Film Type]

Next, a material for forming the film type forming material will be described. Examples of the film type forming material include films containing a norbornene resin, a polycarbonate resin, a cellulose resin, or the like.

First, the film containing the norbornene resin will be described. The norbornene resin is characterized in that the absolute value of the photoelastic coefficient (C[λ], where λ can be set to 590 nm, for example) is small. The absolute value (C[590]) of the photoelastic coefficient of the norbornene resin at the wavelength of 590 nm preferably is in the range of 1×10⁻¹² m²/N to 1×10⁻¹¹ m²/N. In the present invention, the “norbornene resin” refers to a (co)polymer obtained by using a norbornene monomer having a norbornene ring as a part or all of the starting material (a monomer). The term “(co)polymer” means a homopolymer or a copolymer.

As the starting material of the norbornene resin, a norbornene monomer having a norbornene ring (which is a norbornane ring having a double bond) is used. When the norbornene resin is in the form of (co)polymer, the norbornane ring may or may not be present in the constitutional unit. Examples of the norbornene resin having a norbornane ring in the constitutional unit when it is in the form of (co)polymer include tetracyclo[4.4.1^{2,5}.1^{7,10}.0]dec-3-en, 8-methyl tetracyclo[4.4.1^{2,5}.1^{7,10}.0]dec-3-en, and 8-methoxycarbonyl tetracyclo[4.4.1^{2,5}.1^{7,10}.0]dec-3-en. Examples of the norbornene resin not having a norbornane ring in the constitutional unit when it is in the form of (co)polymer include (co)polymers obtained by using a monomer that forms a 5-membered ring upon cleavage. Examples of the monomer that forms a 5-membered ring upon cleavage include norbornene, dicyclopentadiene, 5-phenyl norbornene, and derivatives thereof. When the norbornene resin is a copolymer, the alignment state of its molecules is not particularly limited, and the copolymer may be a random copolymer, a block copolymer, or a graft copolymer.

Examples of the norbornene resin include: (a) a resin obtained by hydrogenating a ring-opening (co)polymer of a norbornene monomer; and (b) a resin obtained through addition (co)polymerization of a norbornene monomer. The resin obtained by hydrogenating a ring-opening copolymer of a norbornene monomer includes a resin obtained by hydrogenating a ring-opening copolymer of at least one kind of norbornene monomer with at least one selected from α-olefins, cycloalkenes, and unconjugated dienes. The resin obtained through addition copolymerization of a norbornene monomer includes a resin obtained through addition copolymerization of at least one kind norbornene monomer with at least one selected from α-olefins, cycloalkenes, and unconjugated dienes.

The resin obtained by hydrogenating a ring-opening (co)polymer of a norbornene monomer can be obtained by, for example, obtaining a ring-opening (co)polymer by causing a metathesis reaction of the norbornene monomer or the like and then hydrogenating the ring-opening (co)polymer. Specifically, this can be achieved by a method described in paragraphs [0059] and [0060] of JP 11(1999)-116780 A, a method described in paragraphs [0035] to [0037] of JP 2001-350017 A, etc., for example. The resin obtained through addition (co)polymerization of a norbornene monomer can be obtained by a method described in Example 1 of JP 61(1986)-292601 A, for example.

With regard to the weight-average molecular weight (Mw) of the norbornene resin, it is preferable that the measured value obtained by a gel permeation chromatography (polystyrene standard) using a tetrahydrofuran solvent is in the range of 20000 to 500000. The glass transition temperature (T_{g}) of the norbornene resin preferably is in the range of 120° C. to 170° C. With the use of the above-described resin, it is possible to obtain an optical compensation layer with an even higher thermal stability and even higher stretchability. The glass transition temperature (Tg) is a value calculated by a differential scanning calorimetry (DSC) method according to JIS K 7121, for example.

A film containing the norbornene resin is produced by stretching a polymer film that is formed into a sheet by a solvent casting method or a melt extrusion method by a longitudinal uniaxial stretching method, a transverse uniaxial stretching method, a longitudinal-transverse simultaneous biaxial stretching method, or a longitudinal-transverse sequential biaxial stretching method, for example. It is preferable that the stretching method is the transverse uniaxial stretching method from the viewpoint of productive efficiency. The temperature at which the polymer film is stretched (the stretching temperature) is preferably in the range of 130° C. to 160° C. The ratio at which the polymer film is stretched (the stretch ratio) is preferably in the range of 1.2 to 4.0 times. The stretching method may be a fixed-end stretching method or a free-end stretching method. According to the fixed-end stretching method, it is possible to produce an optical compensation layer having a refractive index distribution satisfying nx>ny>nz (optical biaxiality).

As the film containing the norbornene resin, it is possible to use a commercially available film as it is, for example. Alternatively, it is possible to use the commercially available film that has been subjected to secondary processing, e.g., at least one of a stretching treatment and a shrinking treatment. Examples of the commercially available film containing the norbornene resin include product named “ARTON” series (ARTON F, ARTON FX, ARTON D) manufactured by JSR Corporation and product named “ZEONOR” series (ZEONOR ZF14, ZEONOR ZF15, ZEONOR ZF16) manufactured by OPTES INC.

Next, the film containing the polycarbonate resin will be described.

As the polycarbonate resin, aromatic polycarbonate composed of an aromatic divalent phenol component and a carbonate component is used preferably. The aromatic polycarbonate generally can be obtained by a reaction of an aromatic divalent phenol compound and a carbonate precursor. That is, the aromatic polycarbonate can be obtained by a phosgene method in which phosgene is blown into the aromatic divalent phenol compound in the presence of a caustic alkali and a solvent or a transesterification method in which an aromatic divalent phenol compound and bisarylcarbonate are subjected to transesterification in the presence of a catalyst.

Examples of the aromatic divalent phenol compound include 2,2-bis(4-hydroxyphenyl)propane, 9,9-bis(4-hydroxyphenyl)fluorene, 4,4′-biphenol, 4,4′-dihydroxybiphenylether, 2,2-bis(3-methyl-4-hydroxyphenyl)propane, 2,2-bis(3-bromo-4-hydroxyphenyl)propane, 2,2-bis(4-hydroxy-3,5-dimethylphenyl)propane, bis(4-hydroxyphenyl)methane, 1,1-bis(4-hydroxyphenyl)ethane, 2,2-bis(4-hydroxyphenyl)butane, 2,2-bis(4-hydroxy-3,5-dimethylphenyl)butane, 2,2-bis(4-hydroxy-3,5-dipropylphenyl)propane, 1,1-bis(4-hydroxyphenyl)cyclohexane, and 1,1-bis(4-hydroxyphenyl)-3,3,5-trimethylcyclohexane. It is to be noted that theses compounds can be used alone or in a combination of two or more of them.

Examples of the carbonate precursor include phosgene, bischloroformates of the divalent phenols, diphenylcarbonate, di-p-tolylcarbonate, phenyl-p-tolyl carbonate, di-p-chlorophenylcarbonate, and dinaphthylcarbonate. Among them, phosgene and diphenylcarbonate are preferred.

The weight-average molecular weight (Mw) of the polycarbonate resin that is measured by gel permeation chromatography (GPC) using a tetrahydrofuran solvent is preferably in the range of 25,000 to 250,000, more preferably in the range of 30,000 to 200,000, and yet more preferably in the range of 40,000 to 100,000. By setting the weight-average molecular weight in the above-described range, an optical compensation layer having superior operability such as solubility, formability, and castability and a superior mechanical strength can be formed.

Among these, as the polycarbonate resin, a polycarbonate resin having a repeating unit (C) represented by the following formula (24) and a repeating unit (D) represented by the following general formula (25) having a fluorene structure preferably is used because it has a superior wavelength dispersion characteristic and allows a retardation value to be generated easily.

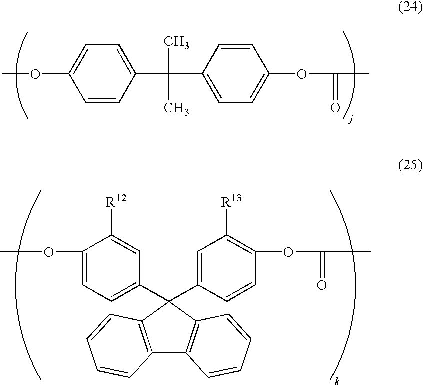

In the formulae (24) and (25), R¹² and R¹³ are each independently a group selected from hydrogen, halogens, halogenated alkyl groups, alkyl groups having 1 to 5 carbon atoms, alkoxy groups having 1 to 5 carbon atoms, alkoxy carbonyl groups having 1 to 5 carbon atoms, alkylcarbonyloxy groups having 1 to 5 carbon atoms, and substituted derivatives thereof. j and k are integers of 1 or more. R¹² and R¹³ each are more preferably an alkyl group having 1 to 5 carbon atoms, and it is particularly preferable that R¹² and R¹³ are both methyl groups.

In polycarbonate having the repeating unit (C) represented by the general formula (24) and the repeating unit (D) represented by the general formula (25), the ratio (C:D) between the repeating unit (C) and the repeating unit (D) preferably satisfies C:D=2:8 to 4:6. By setting the ratio in the above-described range, when an optical compensation layer is formed of this polycarbonate, a retardation value of the optical compensation layer becomes constant in a wide region of visible light. Thus, color shift in the oblique direction in black display of a liquid crystal display can be reduced. It is to be noted that the ratio can be adjusted as appropriate depending on a ratio of each monomer (aromatic divalent phenol component) to be added.

A film containing the polycarbonate resin is produced by stretching a polymer film that is formed into a sheet by a solvent casting method or a melt extrusion method by a longitudinal uniaxial stretching method, a transverse uniaxial stretching method, a longitudinal-transverse simultaneous biaxial stretching method, or a longitudinal-transverse sequential biaxial stretching method, for example. It is preferable that the stretching method is the transverse uniaxial stretching method from the viewpoint of productive efficiency. The temperature at which the polymer film is stretched (the stretching temperature) preferably is in the range of 100° C. to 170° C. The ratio at which the polymer film is stretched (the stretch ratio) preferably is in the range of 1.01 to 2.00 times. The stretching method may be a fixed-end stretching method or a free-end stretching method. According to the fixed-end stretching method, it is possible to produce an optical compensation layer having a refractive index distribution satisfying nx>ny>nz (optical biaxiality).

As the film containing the polycarbonate resin, it is possible to use a commercially available film as it is, for example. Alternatively, it is possible to use the commercially available film that has been subjected to secondary processing such as at least one of a stretching treatment and a shrinking treatment. Examples of the commercially available film containing the polycarbonate resin include product name “PURE-ACE” series manufactured by TEIJIN CHEMICALS LTD., product name “ELMECH” series (R140, R435, and the like) manufactured by KANEKA CORPORATION, and product name “ILLUMINEX” series manufactured by GE Plastics Japan Ltd.

Next, the film containing the cellulose resin will be described.

The cellulose resin preferably is substituted with an acetyl group and a propionyl group. The lower limit of the substitution degree of this cellulose resin, “DSac (acetyl substitution degree)+DSpr (propionyl substitution degree)” (that expresses how many hydroxyl groups among three hydroxyl groups in a repeating unit of cellulose are substituted with an acetyl group or a propionyl group on average), is preferably 2 or more, more preferably 2.3 or more, and yet more preferably 2.6 or more. The upper limit of the “DSac+DSpr” is preferably 3 or less, more preferably 2.9 or less, and yet more preferably 2.8 or less. By setting the substitution degree of the cellulose resin in the above-described range, an optical compensation layer having a desired refractive index distribution such as described above can be obtained.

The lower limit of the DSpr (the propionyl substitution degree) is preferably 1 or more, more preferably 2 or more, and yet more preferably 2.5 or more. The upper limit of the DSpr is preferably 3 or less, more preferably 2.9 or less, and yet more preferably 2.8 or less. By setting the DSpr in the above-described range, the solubility of the cellulose resin to a solvent is improved, thus allowing the thickness of an optical compensation layer to be obtained to be controlled easily. Further, by setting the “DSac+DSpr” in the above-described range and setting the DSpr in the above-described range, an optical compensation layer having the above-describe optical characteristics and wavelength dependency of a reverse dispersion type can be obtained.

The DSac (acetyl substitution degree) and the DSpr (propionyl substitution degree) can be determined by the method described in paragraphs [0016] to [0019] in JP 2003-315538 A.

The cellulose resin may contain a substituent besides an acetyl group and a propionyl group. Examples of the substituent include ester groups such as butyrate, and ether groups such as alkylether groups and aralkylene ether groups.

A number average molecular weight of the cellulose resin is preferably in the range of 5,000 to 100,000, more preferably in the range of 10,000 to 70,000. By setting the number average molecular weight in the above-described range, an optical compensation layer can be obtained with superior productivity, and the mechanical strength of the optical compensation layer is improved.

As a method for substituting a cellulose resin with an acetyl group and a propionyl group, any suitable method is employed. For example, cellulose is treated with a strong caustic soda solution to provide alkali cellulose, and the alkali cellulose is acylated with a predetermined amount of mixture of acetic anhydride and propionic acid anhydride. By partially hydrolyzing an acyl group, a substitution degree “DSac+DSpr” is adjusted.

A film containing a cellulose resin can be produced by solving a cellulose resin in a solvent to prepare a solution, applying the solution to a base to form a coating film, and drying the coating film. To cause retardation such as mentioned above to be generated in the film, the film is subjected to a stretching treatment. The stretching treatment is the same as that for a film containing a norbornene resin. The temperature at which the film is stretched (the stretching temperature) preferably is in the range of 120° C. to 160° C. The ratio at which the film is stretched (the stretch ratio) preferably is in the range of 1.01 to 1.05 times. The stretching is not particularly limited, and is preferably free-end stretching. As the film containing a cellulose resin, a commercially available film may be used.

The film used as the optical compensation layer may further contain any suitable additive. Examples of the additive include plasticizers, thermostabilizers, light stabilizers, lubricants, antioxidants, UV absorbers, flame retardants, colorants, antistatic agents, compatibilizers, crosslinking agents, and thickeners. The content of the additive preferably is more than 0 parts by weight and 10 parts by weight or less with respect to 100 parts by weight of the resin as a main component.

[C. Liquid Crystal Panel]

[C-1. Overall Configuration of Liquid Crystal Panel]

As mentioned above, the liquid crystal panel of the present invention includes a liquid crystal cell and two optical films. The liquid crystal cell is of a multi-domain VA mode, and each of the two optical films is the optical film of the present invention. The two optical films are arranged on a visible side and a backlight side of the liquid crystal cell, respectively, with the optical compensation layer of each of the two optical films being on a liquid crystal cell side. FIG. 2 is a schematic sectional view showing an example of the configuration of the liquid crystal display of the present invention. In FIG. 2, the parts identical to those in FIG. 1 are denoted by the identical reference numerals. As shown in FIG. 2, in this liquid crystal panel 20, optical films 10 of the present invention are arranged on both the visible side (the upper side in FIG. 2) and the backlight side (the lower side in FIG. 2) of a liquid crystal cell 21 in the state where each optical compensation layer 14 is on a liquid crystal cell 21 side. It is preferable that the optical film on the visible side and the optical film on the backlight side are arranged so that their absorption axes are orthogonal to each other.

[C-2. Liquid Crystal Cell]

As mentioned above, the liquid crystal cell is of a multi-domain VA mode. Generally, the liquid crystal cell is configured so that a liquid crystal layer is held between a pair of substrates. FIG. 4 shows an example of the configuration of a liquid crystal cell. As shown in FIG. 4, in a liquid crystal cell 21 of the present example, spacers 212 are arranged between a pair of substrates 211 to form a space, and a liquid crystal layer 213 is held in this space. Although not shown in the drawing, for example, one substrate (an active matrix substrate) included in the pair of substrates is provided with a switching element (for example, a TFT) for controlling the electro-optical characteristics of the liquid crystal and a scanning line for supplying gate signals and a signal line for transmitting source signals to this active element. The other substrate included in the pair of substrates is provided with, for example, a color filter.

The color filter may be provided in the active matrix substrate. The color filter may be omitted when the liquid crystal display includes light sources of three colors, namely, RGB (the liquid crystal display may include light sources for more than three colors) as illuminating means as in the case of a field sequential system, for example. The distance between the pair of substrates (i.e., the cell gap) is controlled by a spacer, for example. The cell gap is in the range of 1.0 to 7.0 μm, for example. On the side of each substrate that is in contact with the liquid crystal layer, an alignment film formed of, e.g., polyimide is provided. The alignment film may be omitted when initial alignment of the liquid crystal molecules is controlled by utilizing a fringe electric field generated by a patterned transparent substrate, for example.

Rth[590] of the liquid crystal cell in the absence of an electric field preferably is in the range of −500 to −200 nm, more preferably from −400 to −200 nm. Rth[590] is set as appropriate by adjusting the birefringence of the liquid crystal molecules and the cell gap, for example.

In the liquid crystal cell, each pixel is divided into plural domains by tilting the liquid crystal molecules in four directions, namely, 45°, 135°, 225°, and 315° counterclockwise with respect to the longitudinal direction of the liquid crystal cell, for example. As above, by causing liquid crystal molecules aligning in the different directions to be present in the liquid crystal cell, a view is not limited to only a specific direction, whereby a wider viewing angle can be realized. Examples of the liquid crystal cell include “ASV (Advanced Super View) mode (product name)” manufactured by Sharp Corporation, “CPA (Continuous Pinwheel Alignment) mode (product name)” manufactured by Sharp Corporation, “MVA (Multi-domain Vertical Alignment) mode (product name)” manufactured by Fujitsu Ltd., “PVA (Patterned Vertical Alignment) mode (product name)” manufactured by Samsung Electronics, “EVA (Enhanced Vertical Alignment) mode (product name)” manufactured by Samsung Electronics, and “SURVIVAL (Super Ranged Viewing Vertical Alignment) mode (product name)” manufactured by Sanyo Electric Co., Ltd. As the liquid crystal cell, it is possible to use a liquid crystal cell equipped in a commercially available liquid crystal display as it is, for example. Examples of a commercially available liquid crystal display including the VA mode liquid crystal cell include liquid crystal televisions “AQUOS” series (product name) manufactured by Sharp Corporation, liquid crystal televisions “BRAVIA” series (product name) manufactured by Sony Corp., a 32V-type wide-screen liquid crystal television “LN32R51B” (product name) manufactured by SAMSUNG, a liquid crystal television “FORIS SC26XD1” (product name) manufactured by Eizo Nanao Corp., and a liquid crystal television “T460HW01” (product name) manufactured by AU Optronics.

[C-3. Improvement in Luminance of White Display in Liquid Crystal Panel]

In the liquid crystal panel of the present example, a luminance of white display is improved as below, for example. That is, light from a backlight passes through a transparent polymer film 11 on the backlight side and then enters a polarizer 12 on the backlight side, where it is converted into linearly polarized light. Further, when the linearly polarized light that has passed through the polarizer 12 on the backlight side enters a λ/4 plate 13 on the backlight side, the linearly polarized light is converted into circularly polarized light because an angle between an absorption axis of the polarizer 12 on the backlight side and a slow axis of the λ/4 plate 13 on the backlight side is set in the range of 45°±5°. Then, the circularly polarized light that has passed through the λ/4 plate 13 on the backlight side enters a liquid crystal cell 21 after passing through an optical compensation layer 14 on the backlight side. In the liquid crystal panel 20 of the present example, light entering the liquid crystal cell 21 is circularly polarized light as above. Therefore, even through some of liquid crystal molecules are tilted in directions that are deviated from the desired directions, all the polarized light passes through the liquid crystal cell 21. Next, when the circularly polarized light that has passed through the liquid crystal cell 21 enters the λ/4 plate 13 on the visible side after passing through the optical compensation layer 14 on the visible side, the circularly polarized light is converted into linearly polarized light because an angle between an absorption axis of the polarizer 12 on the visible side and a slow axis of the λ/4 plate on the visible side is set in the range of 45°±5°. Then, the linearly polarized light that has passed through the λ/4 plate 13 on the visible side passes through a transparent polymer film 11 after passing through the polarizer 12 on the visible side. Thus, improvement in luminance of white display can be achieved in the liquid crystal panel 20 of the present example.

[D. Liquid Crystal Display]

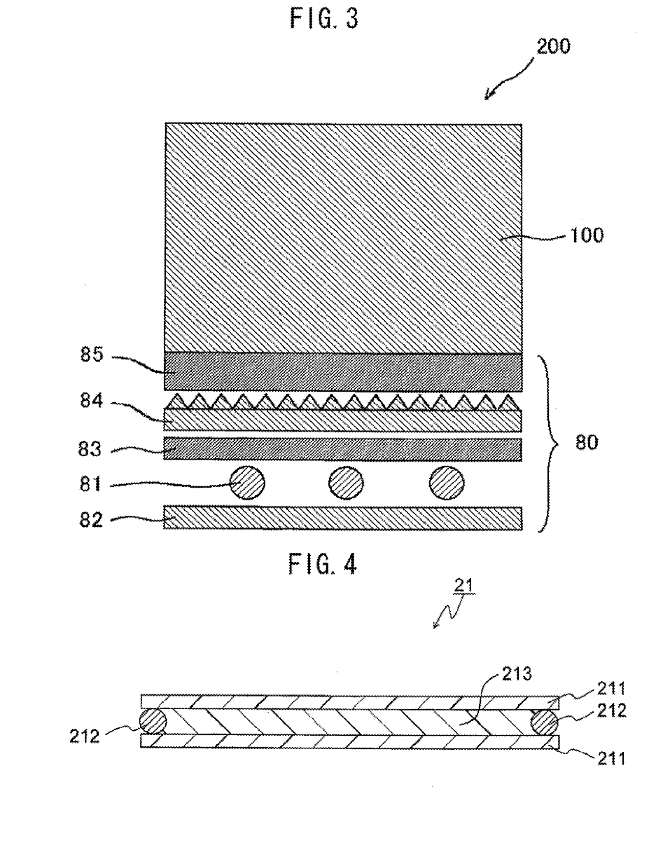

A liquid crystal display of the present invention is characterized in that it includes the liquid crystal panel according to the present invention. FIG. 3 is a schematic sectional view showing the configuration of an example of the liquid crystal display of the present invention. In FIG. 3, the sizes, proportions, etc. of the respective components are different from the actual sizes, proportions, etc, for the sake of simplicity in illustration. As shown in FIG. 3, this liquid crystal display 200 includes at least a liquid crystal panel 100 and a direct-type backlight unit 80 arranged on one side of the liquid crystal panel 100. The direct-type backlight unit 80 includes at least light sources 81, a reflection film 82, a diffusion plate 83, a prism sheet 84, and a brightness enhancement film 85. Although the liquid crystal display 200 according to the present example employs the direct-type backlight unit, the present invention is not limited thereto, and a sidelight-type backlight unit can be used, for example. The sidelight-type backlight unit includes at least a light guide plate and a light reflector, in addition to the configuration of the direct-type backlight unit. Note here that the components shown in FIG. 3 for illustrative purposes can be omitted partially or substituted by another optical element depending on the lighting system of the liquid crystal display, the driving mode of the liquid crystal cell, the intended use, etc. as long as the effect of the present invention can be obtained.

The liquid crystal display of the present invention may be a transmission type liquid crystal display in which the screen is seen by being irradiated with light from the back surface side of the liquid crystal panel, may be a reflection type liquid crystal display in which the screen is seen by being irradiated with light from the display surface side of the liquid crystal panel, or may be a semi-transmission type liquid crystal display having the properties of both the transmission type and the reflection type liquid crystal displays.

The liquid crystal display of the present invention is applicable to any suitable use. Examples of the use thereof include: office automation equipment such as computer monitors, notebook computers, and copy machines; portable devices such as mobile phones, watches, digital cameras, personal digital assistants (PDAs), and portable game devices; household electric appliances such as video cameras, televisions, and microwave ovens; vehicle-mounted devices such as back monitors, car navigation system monitors, and car audios; exhibition devices such as information monitors for commercial stores; security devices such as surveillance monitors; and nursing care and medical devices such as nursing-care monitors and medical monitors.

Preferably, the liquid crystal display of the present invention is used in a television. The screen size of the television preferably is a wide-screen 17-inch type (373 mm×224 mm) or larger, more preferably a wide-screen 23-inch type (499 mm×300 mm) or larger, and still more preferably a wide-screen 32-inch type (687 mm×412 mm) or larger.

### Examples

Next, examples of the present invention will be described together with comparative examples. It is to be noted that the present invention is not limited by the following examples and comparative examples. Various characteristics and physical properties in the respective examples and comparative examples were evaluated and measured by the following methods.

(Luminance of White Display)

A luminance of white display was measured with a product named “BM-5” manufactured by TOPCON CORPORATION. The measurement was carried out in a dark room at a distance of 1 m from a liquid crystal panel with white display. An observation angle was 0.2°.

(Retardation Value at Wavelength of 590 nm (Re[590] and Rth[590]), Nz Coefficient, and T[590])

A retardation value at the wavelength of 590 nm (Re[590] and Rth[590]), a Nz coefficient, and T[590] were measured with product named “KOBRA21-ADH” manufactured by Oji Scientific Instruments at 23° C. An average refractive index was measured with an Abbe refractometer (manufactured by ATAGO CO., LTD, product name “DR-M4”)

(Thickness)

When the thickness was less than 10 μm, the thickness was measured with a spectrophotometer for thin film (manufactured by Otsuka Electronics Co., Ltd., product name “multi channel photo detector MCPD-2000”). When the thickness was 10 μm or more, the thickness was measured with a digital micrometer “KC-351C type” manufactured by Anritsu Corporation.

(Molecular Weight of Polyimide Resin)

A molecular weight of the polyimide resin was measured by the gel permeation chromatography (GPC) using polystyrene oxide as a standard sample. Specifically, the measurement was carried out with the following devices and instruments under the following measurement conditions. Measurement sample: A filtrate obtained by dissolving a specimen in an eluent so as to have a concentration of 0.1% by weight, allowing the resultant solution to stand still for 8 hours, and thereafter filtering the solution with a membrane filter having a pore size of 0.45 μm was used as a sample to be measured.
Analyzing device: manufactured by TOSOH CORPORATION, product name “HLC-8020GPC”
Column: manufactured by TOSOH CORPORATION, product name “GMH_{XL}+GMH_{XL}+G2500H_{XL}”
Column size: each 7. 8 mm diameter×30 cm (a total of 90 cm)
Eluent: dimethylformamide (dimethylformamide solution obtained by adding dimethylformamide to 10 mM lithium bromide and 10 mM phosphoric acid to bring the volume up to 1 L)
Flow rate: 0.8 mL/min
Detector: RI (differential refractmeter)
Column temperature: 40° C.

[Transparent Polymer Film]

### Reference Example 1

A 80 μm thick TAC film (manufactured by FUJIFILM Corporation, product name “80UL”) was prepared. This was used as a transparent polymer film.

[Polarizer]

### Reference Example 2

A 75 μm thick polymer film containing a polyvinyl alcohol resin as a main component (Kuraray Co., Ltd., product name “VF-PS#7500”) was immersed in five baths in the conditions described in [1] to [5] below with a tensile force being applied in the longitudinal direction of the film, whereby the film was stretched so that the final stretch ratio would be 6.2 times its original length. This stretched film was dried in an air circulation oven at 40° C. for 1 minute. Thus, a polarizer was produced.

[Conditions]
[1] Swelling bath: pure water at 30° C.
[2] Dye bath: an aqueous solution at 30° C. containing 0.032 parts by weight of iodine and 0.2 parts by weight of potassium iodide with respect to 100 parts by weight of water.
[3] First crosslinking bath: an aqueous solution at 40° C. containing 3% by weight potassium iodide and 3% by weight boric acid.
[4] Second crosslinking bath: an aqueous solution at 60° C. containing 5% by weight potassium iodide and 4% by weight iodine.
[5] Washing bath: an aqueous solution at 25° C. containing 3% by weight potassium iodide

[λ/4 Plate]

### Reference Example 3

A 100 μm thick polymer film containing a norbornene resin (manufactured by OPTES INC., product name “ZEONOR ZF-14-100”) was stretched 1.25 times by a fixed-end transverse uniaxial stretching method with a tenter stretching machine in an air circulating constant-temperature oven at 150° C. Thus, a λ/4 plate was obtained. Refractive indices of this λ/4 plate exhibited a relationship satisfying nx>ny=nz, and the λ/4 plate had the thickness of 85 μm, and satisfied Re[590]=140 nm, Rth[590]=140 nm, and Nz coefficient at the wavelength of 590 nm=1.0.

### Reference Example 4

A 120 μm thick polymer film containing a cellulose resin (DSac: 0.1 or less, DSpr: 2.8, weight-average molecular weight: 120000) was stretched 1.8 times with a longitudinal stretching machine in an air circulating constant-temperature oven at 140° C. Thus, a λ/4 plate was obtained. Refractive indices of this λ/4 plate exhibited a relationship satisfying nx>ny=nz, and the λ/4 plate had the thickness of 80 μm, and satisfied Re[590]=140 nm, Rth[590]=140 nm, and Nz coefficient at the wavelength of 590 nm=1.0.

[Optical Compensation Layer of Non-Liquid Crystalline Polymer Type]

### Reference Example 5

A 15% by weight polyimide solution was prepared by dissolving polyimide having a weight-average molecular weight (Mw) of 70,000 that is represented by the formula (6) and was synthesized from 2,2-bis(3,4-dicarboxyphenyl)hexafluoropropane dianhydride (6FDA) and 2,2-bis(trifluoromethyl)-4,4-diaminobiphenyl (TFMB) in cyclohexanone. It is to be noted that the synthesis of the polyimide was carried out by the method described in F. Li et al. Polymer 40 (1999) 4571-4581.

Next, the polyimide solution was applied to an 80 μm thick PET film, and the film was dried at 100° C. for 10 minutes. Thus, a transparent and smooth 3.7 μm thick laminate (an optical compensation layer) having a polyimide layer and a PET film was obtained. Refractive indices of this optical compensation layer exhibited a relationship satisfying nx=ny>nz (negative uniaxiality), and the optical compensation layer satisfied T[590]=90%, Re[590]=0 nm, and Rth[590]=300 nm. Further, wavelength dispersion of this optical compensation layer had a positive dispersion characteristic.

[Optical Compensation Layer of Film Type]

### Reference Example 6

A 100 μm thick polymer film containing a norbornene resin (manufactured by OPTES INC., product name “ZEONOR ZF-14-100”) was stretched 2 times in each of a longitudinal direction and a transverse direction with a simultaneous biaxial stretching machine in an air circulating constant-temperature oven at 150° C. Thus, an optical compensation layer was obtained. Refractive indices of this optical compensation layer exhibited a relationship satisfying nx=ny>nz, the thickness of the optical compensation layer was 40 μm, and the optical compensation layer satisfied T[590]=90%, Re[590]=0 nm, and Rth[590]=300 nm.

[Liquid Crystal Cell]

### Reference Example 7

A liquid crystal panel was taken out from a commercially available liquid crystal display (manufactured by Sony Corp., 32-inch liquid crystal television, product name “BRAVIA”) including a multi-domain VA mode liquid crystal cell, and optical films such as polarizing plates and the like arranged on the upper and lower sides of the liquid crystal cell were all removed. Then both sides of a glass plate of this liquid crystal cell were washed. Thus a liquid crystal cell was obtained.

### Example 1

[Optical Film]

On one side of the polarizer of Reference Example 2, the transparent polymer film of Reference Example 1 was attached through an acrylic pressure-sensitive adhesive (thickness: 12 μm). Next, on the other side of the polarizer, the λ/4 plate of Reference Example 3 was attached through an acrylic pressure-sensitive adhesive (thickness: 12 μm) in such a manner that an angle between an absorption axis of the polarizer and a slow axis of the λ/4 plate became 45°. Then, on the side opposite to the polarizer side of the λ/4 plate, the optical compensation layer of Reference Example 5 was attached through an acrylic pressure-sensitive adhesive (thickness: 12 μm). Thus, an optical film A was obtained. At this time, the absorption axis of the polarizer and a slow axis of the optical compensation layer were made to be orthogonal to each other.

[Liquid Crystal Panel and Liquid Crystal Display]

On the visible side of the liquid crystal cell of Reference Example 7, the optical film A was attached through an acrylic pressure-sensitive adhesive (thickness: 20 μm) in such a manner that an optical compensation layer side of the optical film A became a liquid crystal cell side, and an absorption axis direction of the optical film A became parallel to the long-side direction of the liquid crystal cell. Then, on the backlight side of the liquid crystal cell, the optical film A was attached through an acrylic pressure-sensitive adhesive (thickness: 20 μm) in such a manner that the optical compensation layer side became the liquid crystal cell side, and the absorption axis direction of the optical film A became orthogonal to the long-side direction of the liquid crystal cell. Thus, a liquid crystal panel A was obtained. At this time, the absorption axis of the optical film A on the visible side was orthogonal to the absorption axis of the optical film A on the backlight side. A backlight unit included in the original liquid crystal display was then equipped with the liquid crystal panel A, thus producing a liquid crystal display A.

### Example 2

An optical film B, a liquid crystal panel B, and a liquid crystal display B were produced in the same manner as in Example 1 except that the optical compensation layer of Reference Example 6 was used as the optical compensation layer.

### Example 3

An optical film C, a liquid crystal panel C, and a liquid crystal display C were produced in the same manner as in Example 1 except that the λ/4 plate of Reference Example 4 was used as the λ/4 plate.

### Example 4

An optical film D, a liquid crystal panel D, and a liquid crystal display D were produced in the same manner as in Example 2 except that the λ/4 plate of Reference Example 4 was used as the λ/4 plate.

### Comparative Example 1

[Optical Film]

A polarizing plate (manufactured by NITTO DENKO CORPORATION, product name “TEG1465DU”) in which TAC films are laminated on both sides of a polarizer containing a polyvinyl alcohol resin that contains iodine was provided. On one side of the polarizing plate, the optical compensation layer of Reference Example 5 was attached through an acrylic pressure-sensitive adhesive (thickness: 12 μm). Thus, an optical film E was obtained.

[Liquid Crystal Panel and Liquid Crystal Display]

A liquid crystal panel E and a liquid crystal display E were produced in the same manner as in Example 1 except that the above-described optical film E was used as the optical film.

### Comparative Example 2

An optical film F, a liquid crystal panel F, and a liquid crystal display F were produced in the same manner as in Comparative Example 1 except that the optical compensation layer of Reference Example 6 was used as the optical compensation layer.

A luminance of white display of each of the liquid crystal displays obtained in Examples 1 to 4 and Comparative Examples 1 and 2 was measured. The measurement results will be shown in Table 1 below.

TABLE 1

| | Luminance of white display | Relative value*¹ |
|---|---|---|
| Example 1 | 607.6 | 121.7 |
| Example 2 | 586.7 | 117.5 |
| Example 3 | 610.0 | 122.1 |
| Example 4 | 583.0 | 116.7 |
| Comparative Example 1 | 499.5 | 100 |
| Comparative Example 2 | 498.0 | 99.7 |

*¹Relative values obtained assuming that the luminance of Comparative Examples is 100.

As can be seen from Table 1, luminances of white display in Examples 1 to 4 were higher than those in Comparative Examples 1 and 2 in which the optical films include no λ/4 plate s. Further, in Examples 1 and 3 using the optical compensation layers of non-liquid crystalline polymer type, particularly superior display characteristics were exhibited.

### INDUSTRIAL APPLICABILITY

As above, the liquid crystal panel of the present invention is capable of improving a luminance of white display at a low cost without reducing a display quality. Examples of the use of the optical film and the liquid crystal panel using the same, and the liquid crystal display of the present invention include: office automation equipment such as desktop computers, notebook computers, and copy machines; portable devices such as mobile phones, watches, digital cameras, personal digital assistants (PDAs), and portable game devices; household electric appliances such as video cameras, televisions, and microwave ovens; vehicle-mounted devices such as back monitors, car navigation system monitors, and car audios; exhibition devices such as information monitors for commercial stores; security devices such as surveillance monitors; and nursing care and medical devices such as nursing-care monitors and medical monitors. There is no limitation on the use of the optical film and the liquid crystal panel using the same and the liquid crystal display of the present invention, and they are applicable to a wide range of fields.

1. A liquid crystal panel comprising:
a multi-domain VA mode liquid crystal cell; and
two optical films arranged on a visible side and a backlight side of the multi-domain VA mode liquid crystal cell, respectively,
wherein each of the two optical films comprises a transparent polymer film, a polarizer, a λ/4 plate, and an optical compensation layer laminated in this order,
wherein the optical compensation layer comprises at least one non-liquid crystalline polymer selected from the group consisting of polyimides, polyamides, polyesters, polyaryletherketones, polyetherketones, polyamideimides, and polyesterimides, and
wherein an angle between an absorption axis of the polarizer and a slow axis of the λ/4 plate is set in a range of 45°±5°.

2. The liquid crystal panel according to claim 1, wherein an in-plane retardation value Re of the λ/4 plate is in a range of 90 to 180 nm.

3. The liquid crystal panel according to claim 1, wherein the optical compensation layer has a refractive index distribution satisfying nx≧ny>nz.

4-5. (canceled)

6. The liquid crystal panel according to claim 1, wherein the λ/4 plate is formed of at least one resin selected from the group consisting of norbornene resins, polycarbonate resins, cellulose resins, polyvinyl alcohol resins, and polysulfone resins.

7. The liquid crystal panel according to claim 1, wherein the λ/4 plate and the optical compensation layer are attached together through at least one of a pressure-sensitive adhesive layer and an adhesive layer.

8. (canceled)

9. The liquid crystal panel according to claim 1, wherein the optical film on the visible side and the optical film on the backlight side are arranged so that their absorption axes are orthogonal to each other.

10. A liquid crystal display comprising a liquid crystal panel, wherein the liquid crystal panel is the liquid crystal panel according to claim 1.
